(19) United States
(12) Patent Application Publication
(10) Pub. No.: US 2019/0384089 A1
(43) Pub. Date: Dec. 19, 2019

(54) DISPLAY DEVICE

(71) Applicant: Samsung Display Co., Ltd., Yongin-si (KR)

(72) Inventors: Jae Hwan JEON, Asan-si (KR); Jeong Weon Seo, Hwaseong-si (KR); Myung Jong Kim, Seoul (KR)

(21) Appl. No.: 16/365,600

(22) Filed: Mar. 26, 2019

(30) Foreign Application Priority Data
Jun. 18, 2018 (KR) 10-2018-0069870

(51) Int. Cl. G02F 1/1345; G02F 1/1339; G02F 1/1362

(52) U.S. Cl. CPC G02F 1/13452; G02F 1/1339; G02F 2001/136222; G02F 1/13458; G02F 1/136286

(57) ABSTRACT

A display device includes a first display substrate including a plurality of pixels, each of the plurality of pixels being electrically connected to a selection line and a data line; a second display substrate disposed above the first display substrate; a first connection wiring disposed on the first display substrate and electrically connected to the plurality of pixels; a second connection wiring disposed on the second display substrate and electrically connected to the first connection wiring; and a connection pad disposed on a side surface of the first display substrate and a side surface of the second display substrate and electrically connected to the first and second connection wirings.

### CROSS REFERENCE TO RELATED APPLICATION

This application claims priority from and the benefit of Korean Patent Application No. 10-2018-0069870, filed on Jun. 18, 2018, which is hereby incorporated by reference for all purposes as if fully set forth herein.

### BACKGROUND

### Field

Exemplary embodiments/implementations of the invention relate generally to a display device and, more specifically, to a display device including connection wirings which are electrically connected to connection pads on a first display substrate and a second display substrate.

### Discussion of the Background

With the development of multimedia, display devices are becoming increasingly important. Accordingly, various display devices, such as liquid crystal displays (LCDs) and organic light emitting diode displays (OLEDs), are being developed.

In order to drive a light emitting element of a display device, a plurality of wirings for electrically connecting a driver circuit and the light emitting element are required. However, depending on the driving environment of the display device, the reliability of connection between the wirings is often reduced. The reduced connection reliability may lead to a driving failure of the display device. Therefore, research is being conducted to improve reliability of connections between the wirings.

The above information disclosed in this Background section is only for understanding of the background of the inventive concepts, and, therefore, it may contain information that does not constitute prior art.

### SUMMARY

Devices constructed according to exemplary embodiments of the invention may provide a display device with improved operational reliability.

Additional features of the inventive concepts will be set forth in the description which follows, and in part will be apparent from the description, or may be learned by practice of the inventive concepts.

According to one or more embodiments of the invention, a display device includes a first display substrate including a plurality of pixels, each of the plurality of pixels being electrically connected to a selection line and a data line; a second display substrate disposed above the first display substrate; a first connection wiring disposed on the first display substrate and electrically connected to the plurality of pixels; a second connection wiring disposed on the second display substrate and electrically connected to the first connection wiring; and a connection pad disposed on a side surface of the first display substrate and a side surface of the second display substrate and electrically connected to the first and second connection wirings.

The plurality of pixels may include a first pixel and a second pixel different from each other, the first connection wiring may include a third connection wiring electrically connected to the first pixel and a fourth connection wiring electrically connected to the second pixel, and the second connection wiring may include a fifth connection wiring electrically connected to the third connection wiring and a sixth connection wiring electrically connected to the fourth connection wiring.

The fifth connection wiring may be disposed on the second display substrate to overlap the third connection wiring, and the sixth connection wiring may be disposed on the second display substrate to overlap the fourth connection wiring.

The first connection wiring may extend from the side surface of the first display substrate into the first display substrate by a first length, and the second connection wiring may extend from the side surface of the second display substrate into the second display substrate by a second length different from the first length.

The first length may be greater than the second length.

The display device may further include a conductive pattern disposed in a non-display area of the first and second display substrates and electrically connecting the first connection wiring and the second connection wiring.

The conductive pattern may include: a first conductive pattern disposed between the first connection wiring and the second connection wiring and electrically connecting the first connection wiring and the second connection wiring; and a second conductive pattern disposed between the first connection wiring and the second connection wiring to be separated from the first conductive pattern and electrically connecting the first connection wiring and the second connection wiring.

The conductive pattern may include: a first conductive pattern disposed between the first connection wiring and the second connection wiring and is physically cut and unable to electrically connect the first connection wiring and the second connection wiring; and a second conductive pattern disposed between the first connection wiring and the second connection wiring to be separated from the first conductive pattern and electrically connecting the first connection wiring and the second connection wiring.

The display device may further include: a color filter layer disposed on the first display substrate; and a column spacer disposed on the color filter layer, wherein the color filter layer and the column spacer may be disposed between the first display substrate and the second display substrate and between the connection pad and the conductive pattern.

The connection pad may include: a first connection pad disposed on the side surface of the first display substrate and electrically connected to the first connection wiring; and a second connection pad disposed on the side surface of the second display substrate to be separated from the first connection pad and electrically connected to the second connection wiring.

The display device may further include: a flexible circuit board on which a driver chip for driving the pixels is disposed; and an adhesive film electrically connecting the first and second connection pads to the flexible circuit board and covers at least part of the first connection pad and at least part of the second connection pad.

The display device may further include: a flexible circuit board on which a driver chip for driving the pixels is disposed; a first adhesive film disposed on the side surface of the first display substrate and electrically connecting a part of the connection pad to the flexible circuit board; and a second adhesive film disposed on the side surface of the second display substrate to be separated from the first adhesive film and electrically connecting another part of the connection pad to the flexible circuit board.

According to one or more embodiments of the invention, a display device includes: a first display substrate including a display area upon which pixels are disposed, a non-display area, and a first connection wiring disposed in the non-display area; a second display substrate disposed above the first display substrate and including a second connection wiring disposed in the non-display area; a conductive pattern disposed in the non-display area of the first display substrate and electrically connecting the first connection wiring and the second connection wiring; and a connection pad disposed on a side surface of the first display substrate and a side surface of the second display substrate and electrically connected to the first and second connection wirings.

The conductive pattern may include: a first conductive pattern disposed between the first connection wiring and the second connection wiring and electrically connecting the first connection wiring and the second connection wiring; and a second conductive pattern disposed between the first connection wiring and the second connection wiring to be separated from the first conductive pattern and electrically connecting the first connection wiring and the second connection wiring.

The first connection wiring may include a third connection wiring and a fourth connection wiring connected to different pixels, the second connection wiring including a fifth connection wiring disposed to correspond to the third connection wiring and a sixth connection wiring disposed to correspond to the fourth connection wiring, wherein the first conductive pattern may include a third conductive pattern electrically connecting the third connection wiring and the fifth connection wiring and a fourth conductive pattern electrically connecting the fourth connection wiring and the sixth connection wiring and separated from the third conductive pattern, and wherein the second conductive pattern may include a fifth conductive pattern electrically connecting the third connection wiring and the fifth connection wiring and a sixth conductive pattern electrically connecting the fourth connection wiring and the sixth connection wiring and separated from the fifth conductive pattern.

The first connection wiring may extend from the side surface of the first display substrate into the first display substrate by a first length, and the second connection wiring may extend from the side surface of the second display substrate into the second display substrate by a second length different from the first length.

The first length may be greater than the second length.

The display device may further include a flexible circuit board on which a driver chip for driving the pixels is disposed, wherein the driver chip may be electrically connected to the first and second connection wirings by the connection pad.

The display device may further include: a first adhesive film disposed on the side surface of the first display substrate and electrically connecting a part of the connection pad to the flexible circuit board; and a second adhesive film disposed on the side surface of the second display substrate to be separated from the first adhesive film and electrically connecting another part of the connection pad to the flexible circuit board.

The connection pad may include: a first connection pad disposed on the side surface of the first display substrate and electrically connected to the first connection wiring; and a second connection pad disposed on the side surface of the second display substrate to be separated from the first connection pad and electrically connected to the second connection wiring.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of a display device according to an exemplary embodiment.

FIG. 2 is an exploded perspective view of a part of the display device of FIG. 1.

FIG. 3 is a cross-sectional view taken along a sectional line A-A′ of FIG. 1.

FIG. 4 is a perspective view of connection wirings and conductive patterns of FIG. 3.

FIG. 5 illustrates a part of a non-display area of the display device of FIG. 1.

FIG. 6 illustrates a first display substrate of the display device of FIG. 5.

FIG. 7 illustrates a second display substrate of the display device of FIG. 5.

FIG. 8 illustrates an adhesive film in addition to the display device of FIG. 5.

FIG. 9 is a view for explaining the effect of the display device according to an exemplary embodiment.

FIGS. 10 and 11 illustrate a display device according to an exemplary embodiment.

FIG. 12 illustrates a display device according to an exemplary embodiment.

FIG. 13 illustrates a display device according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

In the present specification, a display device refers to a device that provides light, such as a liquid crystal display (LCD), an organic light emitting diode display (OLED), an inorganic light emitting display or a plasma display that displays a screen using a lighting device or light.

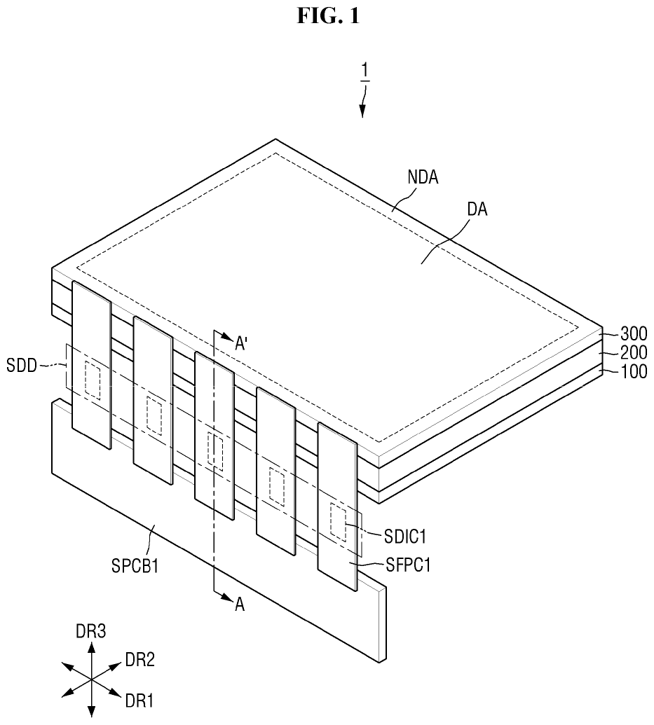

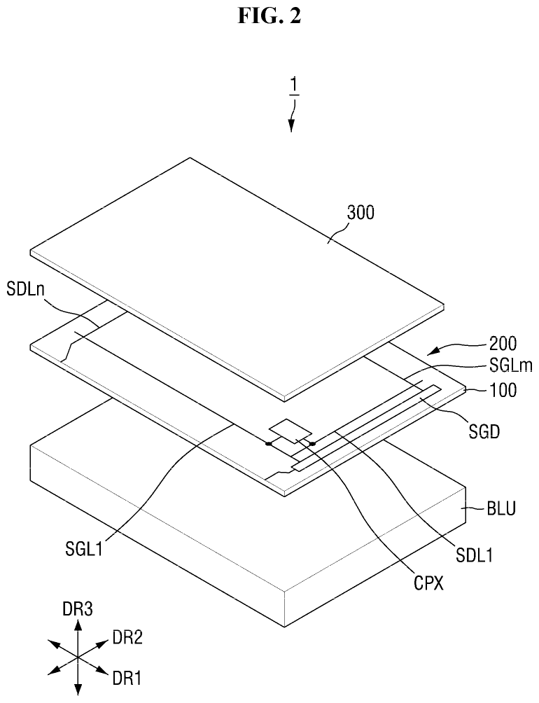

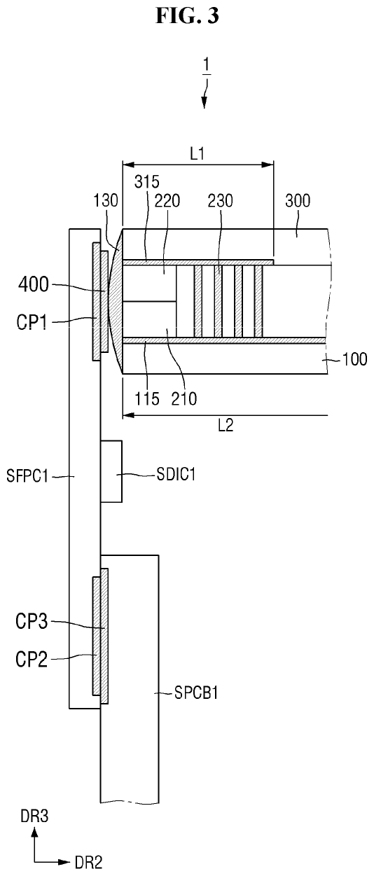

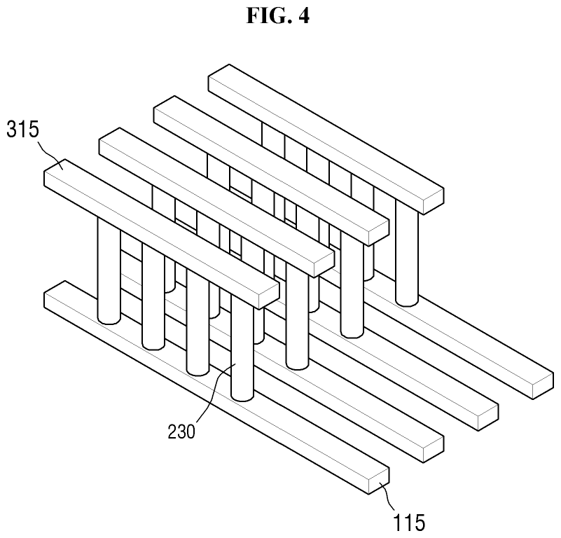

FIG. 1 is a perspective view of a display device 1 according to an exemplary embodiment. FIG. 2 is an exploded perspective view of a part of the display device 1 of FIG. 1. FIG. 3 is a cross-sectional view taken along a sectional line A-A′ of FIG. 1. FIG. 4 is a perspective view of connection wirings and conductive patterns of FIG. 3.

Hereinafter, the technical spirit of the present disclosure will be described using an LCD including a liquid crystal layer as a display device. However, the display device according to the technical spirit of the present disclosure is not limited to the LCD. For example, when a display device (such as an OLED) other than the LCD is employed, some elements to be described below may be omitted, or other elements not described may be added.

The display device according to the inventive concepts may be applied to large electronic equipment such as a television and an external billboard, as well as small and medium electronic equipment such as a personal computer (PC), a notebook computer, a car navigation unit, and a camera. In addition, the display device may be applied to a tablet PC, a smartphone, a personal digital assistant (PDA), a portable multimedia player (PMP), a game machine, and a wristwatch type electronic device. These are only a few exemplary embodiments of the display device according to the inventive concepts, and the display device can be employed in other electronic devices.

Referring to FIGS. 1, 2, 3, and 4, the display device 1 may include a first display substrate 100, a liquid crystal layer 200, and a second display substrate 300. In some exemplary embodiments, the display device 1 may further include flexible circuit boards SFPC1, a driver circuit board SPCB1, and a backlight unit BLU.

Each of the first display substrate 100, the second display substrate 300 and the backlight unit BLU may have, for example, a rectangular shape having long sides in a first direction DR1 and short sides in a second direction DR2 intersecting the first direction DR1. However, the shape of each of the first display substrate 100, the second display substrate 300, and the backlight unit BLU is not limited to the rectangular shape, and each of the first display substrate 100, the second display substrate 300 and the backlight unit BLU may also have curved portions in some regions, if necessary.

The backlight unit BLU may generate light and provide the generated light to the first display substrate 100, the liquid crystal layer 200 and the second display substrate 300. A display panel including the first display substrate 100, the liquid crystal layer 200 and the second display substrate 300 may generate an image using the light received from the backlight unit BLU and provide the generated image to the outside.

The display panel may include a display area DA where an image is displayed and a non-display area NDA where no image is displayed. The non-display area NDA may be, for example, an area surrounding the display area DA. The display device 1 may further include a window member on the second display substrate 300 to cover the display panel and transmit an image to the outside.

The backlight unit BLU may be, but is not limited to, an edge-type backlight unit or a direct-type backlight unit.

The first display substrate 100 may include a plurality of pixels CPX. The pixels CPX may be defined by a plurality of gate lines SGL1 through SGLm (where m is a natural number) and a plurality of data lines SDL1 through SDLn (where n is a natural number). Here, the gate lines SGL1 through SGLm may serve as selection lines for selecting the pixels CPX.

Specifically, the pixels CPX may be defined at intersections of the gate lines SGL1 through SGLm and the data lines SDL1 through SDLn, respectively. In exemplary embodiments, the pixels CPX may not be disposed at the intersections of the gate lines SGL1 through SGLm and the data lines SDL1 through SDLn, respectively, but may be electrically connected to the gate lines SGL1 through SGLm and the data lines SDL1 through SDLn.

Although only one pixel CPX is illustrated in FIG. 2 for ease of description, a plurality of pixels CPX may be substantially defined on the first display substrate 100. A pixel electrode defining a pixel may be disposed in each pixel CPX.

The gate lines SGL1 through SGLm and the data lines SDL1 through SDLn may be insulated from each other and may intersect each other. The gate lines SGL1 through SGLm may extend in the first direction DR1 and may be electrically connected to a gate driver SGD. The data lines SDL1 through SDLn may extend in the second direction DR2 and may be connected to a data driver SDD.

The pixels CPX may be electrically connected to the gate lines SGL1 through SGLm and the data lines SDL1 through SDLn which intersect each other. The pixels CPX may be arranged in, but not limited to, a matrix form.

The gate driver SGD may be disposed in a predetermined region adjacent to at least one of the short sides of the first display substrate 100. However, the position of the gate driver SGD is not limited to this example.

The gate driver SGD may be formed at the same time as the manufacturing process of transistors for driving the pixels CPX and may be mounted on the first display substrate 100 in the form of an amorphous silicon TFT gate driver circuit (ASG) or an oxide silicon TFT gate driver circuit (OSG).

However, the exemplary embodiments are not limited to this case, and the gate driver SGD may also be formed of a plurality of driver chips, mounted on a flexible driver circuit board, and then connected to the first display substrate 100 by a tape carrier package (TCP) method. Alternatively, the gate driver SGD may be formed of a plurality of driver chips and mounted on the first display substrate 100 by a chip-on-glass (COG) method.

The data driver SDD may include a plurality of source driver chips SDIC1. The source driver chips SDIC1 may be mounted on the flexible circuit boards SFPC1 and electrically connected to a predetermined region (e.g., a side surface) adjacent to a long side of the first display substrate 100 and a long side of the second display substrate 300.

Although the flexible circuit boards SFPC1 are connected adjacent to the long sides of the first and second display substrates 100 and 300 in the drawings, the exemplary embodiments are not limited to this case. The position where the first and second display substrates 100 and 300 are connected to the flexible circuit boards SFPC1 can be changed as needed.

The source driver chips SDIC1 may be mounted on the flexible circuit boards SFPC1 and electrically connected to contact pads CP1, and the contact pads CP1 of the flexible circuit boards SFCP1 may be electrically connected to connection pads 130 disposed on a side surface of the first display substrate 100 and a side surface of the second display substrate 300 by an adhesive film 400.

As illustrated in FIG. 3, the connection pads 130 may be electrically connected to first connection wirings 115 arranged on the first display substrate 100 and second connection wirings 315 arranged on the second display substrate 300. As will be described later, the first connection wirings 115 may extend from the side surface of the first display substrate 100 into the first display substrate 100 (e.g., extend in the second direction DR2) and may be electrically connected to the pixels CPX.

The second connection wirings 315 may extend from the side surface of the second display substrate 300 into the second display substrate 300 (e.g., extend in the second. direction DR2). Here, an extension length L1 of the second connection wirings 315 and an extension length L2 of the first connection wirings 115 may be different from each other. Specifically, the first connection wirings 115 may extend deeper into the first display substrate 100 so as to be electrically connected to the pixels CPX, but the second connection wirings 315 may not extend into the second display substrate 300 as far as the first connection wirings 115. That is, the extension length L2 of the first connection wirings 115 may be greater than the extension length L1 of the second connection wirings 315.

The second connection wirings 315 may be electrically connected to the first connection wirings 115 by conductive patterns 230. A plurality of conductive patterns 230 may be disposed as illustrated in the drawings. That is, a plurality of conductive patterns 230 may be extending in the third direction DR3 between the first display substrate 100 and the second display substrate 300 and arranged in a direction (e.g., the second direction DR2) toward the inside of the first display substrate 100 and the second display substrate 300. The conductive patterns 230 may be disposed in the non-display area NDA of the display panel.

Referring to FIG. 4, a plurality of conductive patterns 230 may be arranged to electrically connect one first connection wiring 115 and one second connection wiring 315. When a plurality of conductive patterns 230 are arranged, even if a defect occurs in some of the conductive patterns 230, the first connection wiring 115 and the second connection wiring 315 may still be electrically connected to each other by the other conductive patterns 230. Although FIG. 4 illustrates four conductive patterns 230 arranged to electrically connect one first connection wiring 115 and one second connection wiring 315, the exemplary embodiments are not limited to this case. The number of the conductive patterns 230 can be changed as needed.

A plurality of first connection wirings 115 may be disposed on the first display substrate 100 as illustrated in the drawing. The second connection wirings 315 respectively corresponding to the first connection wirings 115 may be disposed on the second display substrate 300. As illustrated in the drawing, a plurality of conductive patterns 230 may be disposed between each first connection wiring 115 and each second connection wiring 315.

In exemplary embodiments, the conductive patterns 230 may have a columnar structure as illustrated in the drawing. However, the shape of the conductive patterns 230 that electrically connect the first connection wirings 115 and the second connection wirings 315 can be changed as desired.

In an exemplary embodiment, the conductive patterns 230 may include, for example, silver (Ag). In some other exemplary embodiments, the conductive patterns 230 may be formed by patters Ag nano wires.

Referring to FIG. 3, a color filter layer 210 and a column spacer 220 may be disposed between the first display substrate 100 and the second display substrate 300 in a region adjacent to the connection pads 130.

The color filter layer 210 may serve to improve the quality of an image output from the display device 1. The color filter layer 210 may include, but is not limited to, blue photoresist.

The column spacer 220 may be disposed on the color filter layer 210. The column spacer 220 may maintain the distance between the first display substrate 100 and the second display substrate 300 and support the second display substrate 300.

The driver circuit board SPCB1 may be electrically connected to the flexible circuit boards SFPC1. Specifically, contact pads CP2 of the flexible circuit boards SFPC1 and contact pads CP3 of the driver circuit board SPCB1 may be electrically connected so that the flexible circuit boards SFPC1 and SPCB1 are electrically connected.

Accordingly, the source driver chips SDIC1 may also be electrically connected to the driver circuit board SPCB1.

In exemplary embodiments, the flexible circuit boards SFPC1 may be provided in the form of flexible printed circuit boards. Specifically, the flexible circuit boards SFPC1 may be configured in a chip-on-film (COF) form. Accordingly, the data driver SDD may be connected to the first and second display substrates 100 and 300 and the driver circuit board SPCB1 by a TCP method.

The driver circuit board SPCB1 may include, for example, a timing controller. The timing controller may be mounted on the driver circuit board SPCB1 in the form of an integrated circuit chip and electrically connected to the gate driver SGD and the data driver SDD. The timing controller may output a gate control signal, a data control signal, and image data.

The gate driver SGD may receive the gate control signal from the timing controller. The gate driver SGD may generate gate signals in response to the gate control signal and sequentially output the generated gate signals. The gate signals may be provided to the pixels PX on a row-by-row basis through the gate lines SGL1 through SGLm. As a result, the pixels CPX may be driven on a row-by-row basis.

The data driver SDD may receive the image data and the data control signal from the timing controller. The data driver SDD may generate and output analog data voltages corresponding to the image data in response to the data control signal. The data voltages may be provided to the pixels CPX through the data lines SDL1 through SDLn.

The pixels CPX may receive the data voltages through the data lines SDL1 through SDLn in response to the gate signals received through the gate lines SGL1 through SGLm. The pixels CPX may display gray levels corresponding to the data voltages, thereby controlling the transmittance of a region in which each pixel CPX is disposed.

The second display substrate 300 may be disposed above the first display substrate 100. Specifically, the second display substrate 300 may be spaced apart from the first display substrate 100 in a third direction DR3. The liquid crystal layer 200 may be disposed between the second display substrate 300 and the first display substrate 100. A common electrode for applying an electric field to the liquid crystal layer 200 together with the pixel electrodes of the first display substrate 100 may be disposed on the second display substrate 300. In addition, a color filter for realizing a color corresponding to each of the pixels CPX described above may be disposed on the second display substrate 300. The second display substrate 300 may include the second connection wirings 315 disposed at positions corresponding to the first connection wirings 115 disposed on the first display substrate 100.

An optical sheet including a polarizing sheet may be disposed between the backlight unit BLU and the first display substrate 100. The optical sheet may control the characteristics of light received from the backlight unit BLU so that the transmittance of the light passing through the display panel is smoothly controlled. In addition, the display device 1 may further include a housing member that can house the backlight unit BLU and the display panel.

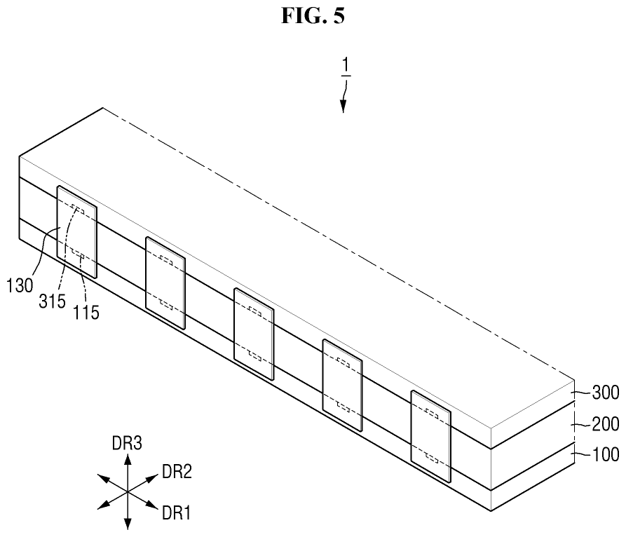

The arrangement of the first connection wirings 115, the second connection wirings 315, and the connection pads 130 will now be described in more detail with reference to FIGS. 5, 6, and 7.

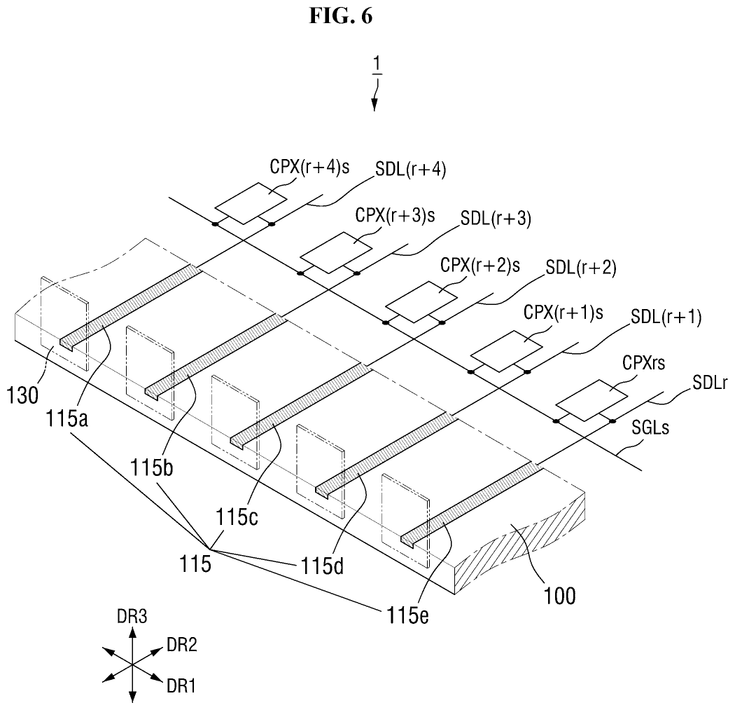

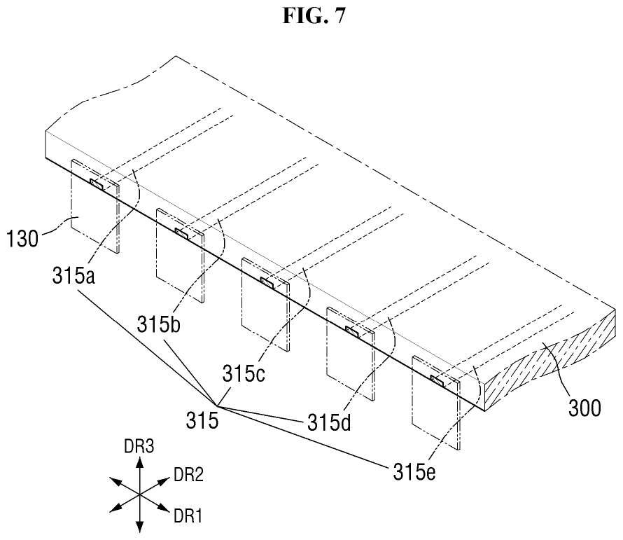

FIG. 5 illustrates a part of the non-display area NDA of the display device 1 of FIG. 1. FIG. 6 illustrates the first display substrate 100 of the display device 1 of FIG. 5. FIG. 7 illustrates the second display substrate 300 of the display device 1 of FIG. 5.

Referring to FIGS. 5, 6, and 7, the connection pads 130 for electrical connection with the flexible circuit boards SFPC1 may be disposed on a side surface of the first display substrate 100 and a side surface of the second display substrate 300. Since the connection pads 130 are disposed on the side surface of the first display substrate 100 and the side surface of the second display substrate 300 in the display device 1 according to the current exemplary embodiment, the non-display area NDA can be minimized or reduced.

In exemplary embodiments, the connection pads 130 may cover all of the side surfaces of the first display substrate 100 and the second display substrate 300, as illustrated in the drawings. Specifically, the connection pads 130 may be electrically connected to the first s connection wirings 115 disposed on the first display substrate 100 and the second connection wirings 315 disposed on the second display substrate 300 and may cover all of the side surfaces of the first display substrate 100, the liquid crystal layer 200 and the second display substrate 300.

The connection pads 130 may include, but is not limited to, silver (Ag).

First connection wirings 115a, 115b, 115c, 115d, and 115e may be electrically connected to a plurality of data lines SDLr, SDL(r+1), SDL(r+2), SDL(r+3), and SDL(r+4) (where r is a natural number), respectively, as illustrated in the drawings. Accordingly, the connection pads 130 may also be electrically connected to the data lines SDLr, SDL(r+1), SDL(r+2), SDL(r+3), and SDL(r+4), respectively.

A gate line SGLs (where s is a natural number) may intersect the data lines SDLr, SDL(r+1), SDL(r+2), SDL(r+3), and SDL(r+4). A plurality of pixels CPXrs, CPX(r+1)s, CPX(r+2)s, CPX(r+3)s, and CPX(r+4)s may be electrically connected to the gate line SGLs.

Although only five first connection wirings 115a, 115b, 115c, 115d, and 115e are illustrated in the drawings, this is only for ease of understanding, and the actual number of the first connection wirings 115a, 115b, 115c, 115d, and 115e electrically connected to the data lines SDLr, SDL(r+1), SDL(r+2), SDL(r+3), and SDL(r+4) may be greater or smaller than five.

The data lines SDLr, SDL(r+1), SDL(r+2), SDL(r+3), and SDL(r+4) may be electrically connected to the pixels CPXrs, CPX(r+1)s, CPX(r+2)s, CPX(r+3)s, and CPX(r+4)s, respectively. Accordingly, the first connection wirings 115a, 115b, 115c, 115d, and 115e may be electrically connected to the pixels CPXrs, CPX(r+1)s, CPX(r+2)s, CPX(r+3)s, and CPX(r+4)s, respectively. In addition, the connection pads 130 may be electrically connected to the pixels CPXrs, CPX(r+1)s, CPX(r+2)s, CPX(r+3)s, and CPX(r+4)s, respectively.

Second connection wirings 315a, 315b, 315c, 315d, and 315e may be disposed on the second display substrate 300 at positions corresponding to the first connection wirings 115a, 115b, 115c, 115d, and 115e. In other words, when the second display substrate 300 is placed above the first display substrate 100, the second connection wirings 315a, 315b, 315c, 315d, and 315e may overlap the corresponding first connection wirings 115a, 115b, 115c, 115d, and 115e, respectively (see FIG. 4).

The second connection wirings 315a, 315b, 315c, 315d, and 315e may respectively be electrically connected to the first connection wirings 115a, 115b, 115c, 115d, and 115e by the conductive patterns 230 described above with reference to FIG. 4. Accordingly, the second connection wirings 315a, 315b, 315c, 315d, and 315e may also be electrically connected to the data lines SDLr, SDL(r+1), SDL(r+2), SDL(r+3), and SDL(r+4) by the first connection wirings 115a, 115b, 115c, 115d, and 115e, respectively.

The first connection wirings 115a, 115b, 115c, 115d, and 115e and the second connection wirings 315a, 315b, 315c, 315d, and 315e may include, but are not limited to, copper (Cu).

Referring also to FIG. 1, the source driver chips SDIC1 mounted on the flexible circuit boards SFPC1 may generate data voltages needed to drive the pixels CPXrs, CPX(r+1)s, CPX(r+2)s, CPX(r+3)s, and CPX(r+4)s electrically connected through the connection pads 130. The data voltages thus generated may be transferred to the data lines SDLr, SDL(r+1), SDL(r+2), SDL(r+3), and SDL(r+4) through the connection pads 130.

While a case where the first and second connection wirings 115 and 315 are electrically connected to the data lines SDLr, SDL(r+1), SDL(r+2), SDL(r+3), and SDL(r+4) has been described above as an example, embodiments according to the technical spirit of the present disclosure are limited to this case. According to the technical spirit of the present disclosure, the first and second connection wirings 115 and 315 and the connection pads 130 may also be arranged in a similar manner and electrically connected to the gate lines SGL1 through SGLm (see FIG. 2) or other wirings of the first display substrate 100.

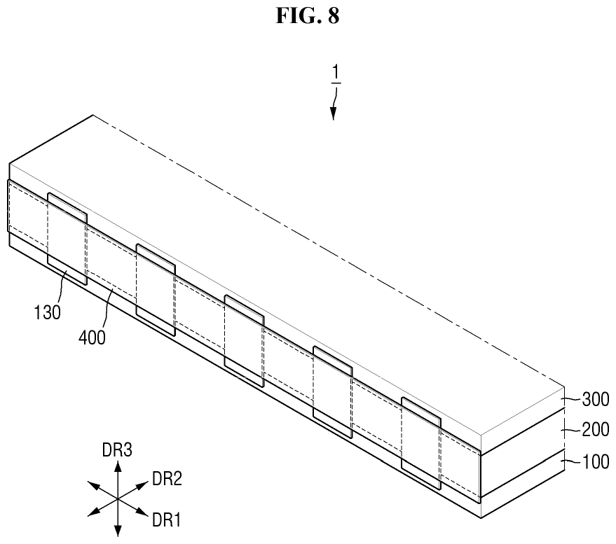

The placement of the adhesive film 400 for electrically connecting the connection pads 130 disposed on the side surfaces of the first and second display substrates 100 and 300 to the flexible circuit boards SFPC1 will now be described in more detail with reference to FIG. 8.

FIG. 8 illustrates the adhesive film 400 in addition to the display device 1 of FIG. 5.

Referring to FIGS. 3 and 8, the connection pads 130 are electrically connected to the contact pads CP1 of the flexible circuit boards SFPC1. For example, the connection pads 130 may be electrically connected to the contact pads CP1 of the flexible circuit boards SFPC1 by an outer lead bonding (OLB) method.

In exemplary embodiments, the adhesive film 400 may partially expose the connection pads 130 covering all of the side surfaces of the first display substrate 100, the liquid crystal layer 200 and the second display substrate 300, as illustrated in the drawings.

In exemplary embodiments, the adhesive film 400 may include an anisotropic conductive film (ACF). When the adhesive film 400 is an ACF, it may have conductivity only in regions where the connection pads 130 and the contact pads CP1 of the flexible circuit boards SFPC1 contact each other, thus electrically connecting the connection pads 130 to the contact pads CP1 of the flexible circuit boards SFPC1.

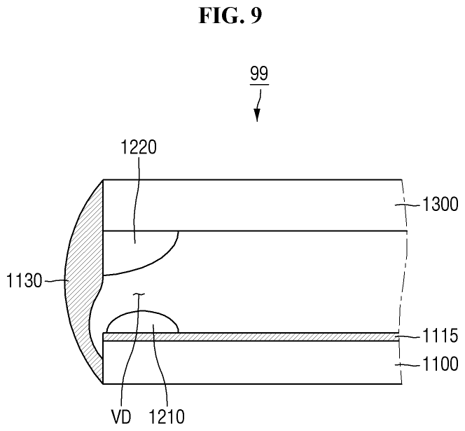

FIG. 9 is a view for explaining the effect of the display device 1 according to an exemplary embodiment.

FIG. 9 illustrates a display device 99 according to a comparable embodiment, in which a connection wiring 1115 is disposed only on a first display substrate 1100, unlike the display device 1 according to the exemplary embodiments as described above.

Referring to FIG. 9, depending on the environment in which the display device 99 according to the comparable embodiment is operated, a defect may occur between elements disposed on the first display substrate 1100 and a second display substrate 1300. For example, if the display device 99 is operated in a high-temperature or high-humidity environment, a void VD may be generated between a color filter layer 1210 and a column spacer 1220 as illustrated in the drawing. The void VD may affect a connection pad 1130 disposed on a side surface of the first display substrate 1100 and a side surface of the second display substrate 1300, causing a connection failure between the connection wiring 1115 and the connection pad 1130. The connection failure between the connection wiring 1115 and the connection pad 1130 may render the display device 99 unable to display an image properly.

On the other hand, as illustrated in FIG. 3, the display device 1 according to the exemplary embodiment described above includes the second connection wirings 315 on the second display substrate 300, and the second connection wirings 315 and the first connection wirings 115 are electrically connected using the conductive patterns 230. Therefore, a connection failure between the connection wirings 115 and 315 and the connection pads 130 can be minimized or reduced. That is, since a plurality of conductive paths are provided between the connection pads 130 and the pixels CPX disposed on the first display substrate 100, the probability of connection failure can be reduced.

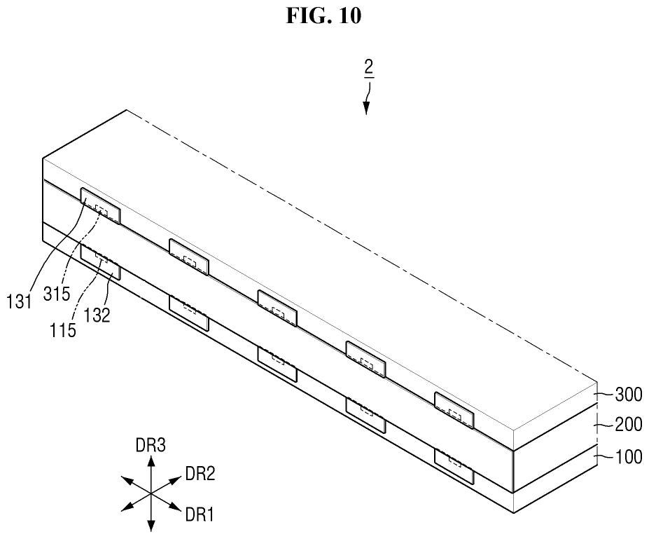

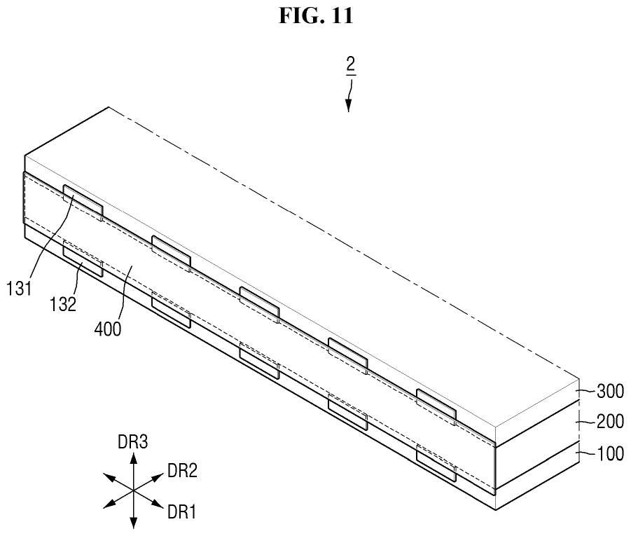

FIGS. 10 and 11 illustrate a display device 2 according to exemplary embodiments. Elements and features identical to those of the above-described embodiments will be omitted, and differences will be mainly described below.

Referring first to FIG. 10, the display device 2 may include first connection pads 132 and second connection pads 131 which are separated from each other.

The first connection pads 132 may be electrically connected to first connection wirings 115 disposed on a first display substrate 100 and may be disposed on a side surface of the first display substrate 100. The first connection pads 132 may not be disposed on a side surface of a second display substrate 300, unlike the connection pads 130 (see FIG. 5) described above.

The second connection pads 131 may be electrically connected to second connection wirings 315 disposed on the second display substrate 300 and may be disposed on the side surface of the second display substrate 300. The second connection pads 131 may not be disposed on the side surface of the first display substrate 100, unlike the connection pads 130 (see FIG. 5) described above.

Referring next to FIG. 11, in the display device 2, an adhesive film 400 may cover at least part of the first connection pads 132 and at least part of the second connection pads 131 separated from each other and may electrically connect the first connection pads 132 and the second connection pads 131 to flexible circuit boards SFPC1 (see FIG. 3). That is, the adhesive film 400 may be disposed on the side surfaces of the first display substrate 100, a liquid crystal layer 200 and the second display substrate 300 to electrically connect the first connection pads 132 and the second connection pads 131 to the flexible circuit boards SFPC1 (see FIG. 3).

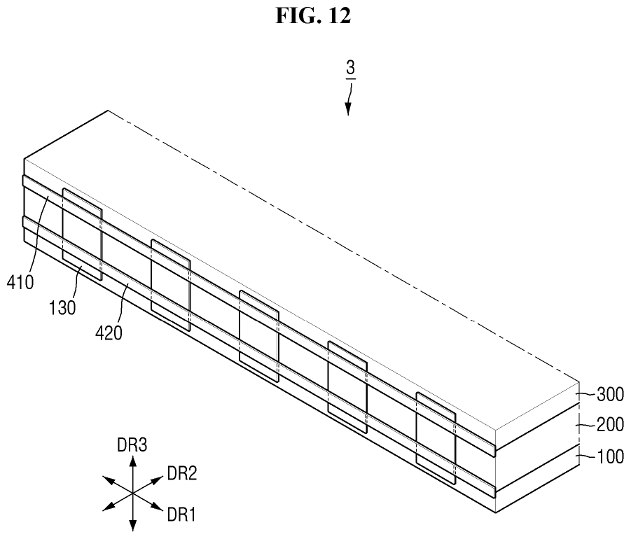

FIG. 12 illustrates a display device 3 according to exemplary embodiments. The current embodiments will be described below, focusing mainly on differences from the above-described embodiments.

Referring to FIG. 12, the display device 3 may include connection pads 130 disposed on side surfaces of a first display substrate 100, a liquid crystal layer 200 and a second display substrate 300 and may include a first adhesive film 420 and a second adhesive film 410 separated from each other.

The first adhesive film 420 may be disposed on the side surface of the first display substrate 100 to electrically connect a part of each connection pad 130 to a flexible circuit board SFPC1 (see FIG. 3).

The second adhesive film 410 may be disposed on the side surface of the second display substrate 300 to electrically connect another part of each connection pads 130 to the flexible circuit board SFPC1 (see FIG. 3).

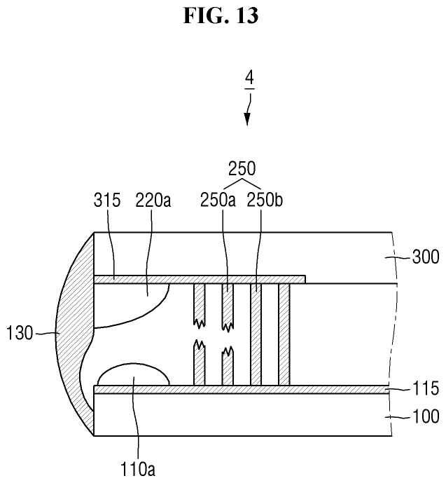

FIG. 13 illustrates a display device 4 according to exemplary embodiments.

Referring to FIG. 13, the display device 4 may include a color filter layer 110a and a column spacer 220a, and the color filter layer 110a and the column spacer 220a may be separated from each other.

In exemplary embodiments, due to a void between the color filter layer 110a and the column spacer 220a, a connection pad 130 may be open-circuited from a first connection wiring 115 and electrically connected to a second connection wiring 315.

In exemplary embodiments, conductive patterns 250 may include first conductive patterns 250a which are cut and thus unable to electrically connect the first connection wiring 115 and the second connection wiring 315 and second conductive patterns 250b which electrically connect the first connection wiring 115 and the second connection wiring 315.

According to the exemplary embodiments, a display device includes a plurality of conductive paths are disposed between a connection pad disposed on a side surface of a display substrate and a plurality of pixels disposed on the display substrate. Therefore, the probability of connection failure can be reduced.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a first display substrate comprising a plurality of pixels, each of the plurality of pixels being electrically connected to a selection line and a data line;
a second display substrate disposed above the first display substrate;
a first connection wiring disposed on the first display substrate and electrically connected to the plurality of pixels;
a second connection wiring disposed on the second display substrate and electrically connected to the first connection wiring; and
a connection pad disposed on a side surface of the first display substrate and a side surface of the second display substrate and electrically connected to the first and second connection wirings.

2. The display device of claim 1, wherein the plurality of pixels comprises a first pixel and a second pixel different from each other, the first connection wiring comprises a third connection wiring electrically connected to the first pixel and a fourth connection wiring electrically connected to the second pixel, and the second connection wiring comprises a fifth connection wiring electrically connected to the third connection wiring and a sixth connection wiring electrically connected to the fourth connection wiring.

3. The display device of claim 2, wherein the fifth connection wiring is disposed on the second display substrate to overlap the third connection wiring, and the sixth connection wiring is disposed on the second display substrate to overlap the fourth connection wiring.

4. The display device of claim 1, wherein the first connection wiring extends from the side surface of the first display substrate into the first display substrate by a first length, and the second connection wiring extends from the side surface of the second display substrate into the second display substrate by a second length different from the first length.

5. The display device of claim 4, wherein the first length is greater than the second length.

6. The display device of claim 1, further comprising a conductive pattern disposed in a non-display area of the first and second display substrates and electrically connecting the first connection wiring and the second connection wiring.

7. The display device of claim 6, wherein the conductive pattern comprises:
a first conductive pattern disposed between the first connection wiring and the second connection wiring and electrically connecting the first connection wiring and the second connection wiring; and
a second conductive pattern disposed between the first connection wiring and the second connection wiring to be separated from the first conductive pattern and electrically connecting the first connection wiring and the second connection wiring.

8. The display device of claim 6, wherein the conductive pattern comprises:
a first conductive pattern disposed between the first connection wiring and the second connection wiring and is physically cut and unable to electrically connect the first connection wiring and the second connection wiring; and
a second conductive pattern disposed between the first connection wiring and the second connection wiring to be separated from the first conductive pattern and electrically connecting the first connection wiring and the second connection wiring.

9. The display device of claim 6, further comprising:
a color filter layer disposed on the first display substrate; and
a column spacer disposed on the color filter layer,
wherein the color filter layer and the column spacer are disposed between the first display substrate and the second display substrate and between the connection pad and the conductive pattern.

10. The display device of claim 1, wherein the connection pad comprises:
a first connection pad disposed on the side surface of the first display substrate and electrically connected to the first connection wiring; and
a second connection pad disposed on the side surface of the second display substrate to be separated from the first connection pad and electrically connected to the second connection wiring.

11. The display device of claim 10, further comprising:
a flexible circuit board on which a driver chip for driving the pixels is disposed; and
an adhesive film electrically connecting the first and second connection pads to the flexible circuit board and covers at least part of the first connection pad and at least part of the second connection pad.

12. The display device of claim 1, further comprising:
a flexible circuit board on which a driver chip for driving the pixels is disposed;
a first adhesive film disposed on the side surface of the first display substrate and electrically connecting a part of the connection pad to the flexible circuit board; and
a second adhesive film disposed on the side surface of the second display substrate to be separated from the first adhesive film and electrically connecting another part of the connection pad to the flexible circuit board.

13. A display device comprising:
a first display substrate comprising a display area upon which pixels are disposed, a non-display area, and a first connection wiring disposed in the non-display area;
a second display substrate disposed above the first display substrate and comprising a second connection wiring disposed in the non-display area;
a conductive pattern disposed in the non-display area of the first display substrate and electrically connecting the first connection wiring and the second connection wiring; and
a connection pad disposed on a side surface of the first display substrate and a side surface of the second display substrate and electrically connected to the first and second connection wirings.

14. The display device of claim 13, wherein the conductive pattern comprises:
a first conductive pattern disposed between the first connection wiring and the second connection wiring and electrically connecting the first connection wiring and the second connection wiring; and
a second conductive pattern disposed between the first connection wiring and the second connection wiring to be separated from the first conductive pattern and electrically connecting the first connection wiring and the second connection wiring.

15. The display device of claim 14, wherein the first connection wiring comprises a third connection wiring and a fourth connection wiring connected to different pixels, the second connection wiring comprises a fifth connection wiring disposed to correspond to the third connection wiring and a sixth connection wiring disposed to correspond to the fourth connection wiring,
wherein the first conductive pattern comprises a third conductive pattern electrically connecting the third connection wiring and the fifth connection wiring and a fourth conductive pattern electrically connecting the fourth connection wiring and the sixth connection wiring and separated from the third conductive pattern, and
wherein the second conductive pattern comprises a fifth conductive pattern electrically connecting the third connection wiring and the fifth connection wiring and a sixth conductive pattern electrically connecting the fourth connection wiring and the sixth connection wiring and separated from the fifth conductive pattern.

16. The display device of claim 13, wherein the first connection wiring extends from the side surface of the first display substrate into the first display substrate by a first length, and the second connection wiring extends from the side surface of the second display substrate into the second display substrate by a second length different from the first length.

17. The display device of claim 16, wherein the first length is greater than the second length.

18. The display device of claim 13, further comprising a flexible circuit board on which a driver chip for driving the pixels is disposed, wherein the driver chip is electrically connected to the first and second connection wirings by the connection pad.

19. The display device of claim 18, further comprising:
a first adhesive film disposed on the side surface of the first display substrate and electrically connecting a part of the connection pad to the flexible circuit board; and
a second adhesive film disposed on the side surface of the second display substrate to be separated from the first adhesive film and electrically connecting another part of the connection pad to the flexible circuit board.

20. The display device of claim 13, wherein the connection pad comprises:
a first connection pad disposed on the side surface of the first display substrate and electrically connected to the first connection wiring; and
a second connection pad disposed on the side surface of the second display substrate to be separated from the first connection pad and electrically connected to the second connection wiring.
